(19) United States
(12) Patent Application Publication
(10) Pub. No.: US 2013/0182086 A1
(43) Pub. Date: Jul. 18, 2013

(54) APPARATUS FOR ENHANCING STEREOSCOPIC IMAGES

(71) Applicants: Allan Thomas Evans, Ann Arbor, MI (US); Edward Tang, Ann Arbor, MI (US)

(72) Inventors: Allan Thomas Evans, Ann Arbor, MI (US); Edward Tang, Ann Arbor, MI (US)

(21) Appl. No.: 13/792,267

(22) Filed: Mar. 11, 2013

(51) Int. Cl. H04N 13/04

(52) U.S. Cl. CPC H04N 13/044
USPC 348/53

(57) ABSTRACT

The ability of some people to perceive simulated stereoscopic images or even actual stereoscopic images can be enhanced by treating the two eyes differently. The disclosed system can enhance stereoscopic images by selectively modifying the incoming images using right/left differentiation filter. The system can also include the capability of filtering images using parameters that for which the right eye and left eye images are treated independently of each other.

### BACKGROUND OF THE INVENTION

The invention is a system, apparatus, and method for enhancing stereoscopic images that includes a right/left differential filter (collectively the “system”).

Stereoscopic images are commonly referred to as three-dimensional (“3D”) images. Stereoscopic means collectively “(1) pertaining to three-dimensional vision or (2) any of various processes and devices for giving the illusion of depth from two-dimensional images or reproductions”. Stereoscopic perception can involve actual 3D perception as well as simulated 3D using the fusion of two two-dimensional images. Over time, technologies have been developed that allow man-made media to simulate stereoscopic images on a 2-D surface such as a movie screen or television screen. Different configurations of monocular and binocular cues are utilized in different approaches to the display of stereoscopic images on 2-D screens.

The perception of stereoscopic images by human beings involves the fusing together of images viewed by the right and left eyes. Human beings rely on a variety of one-eye (“monocular”) cues and two-eye (“binocular”) cues in perceiving depth and the stereoscopic images of the physical world. Unfortunately, the ability of many people to perceive both actual stereoscopic images and simulated stereoscopic images (collectively “stereoscopic images”) is negatively impacted by differences between their two eyes. There are a variety of different conditions that can result in one eye being too dominant over the other eye. If the differential between the right and left eye (the “right/left differential”), then the ability of that person to perceive stereoscopic images is significantly impeded. In many instances, the person will not even realize the magnitude of their impediment.

Many people with satisfactory depth perception in the context of the physical world are unable to fully or even partially perceive the stereoscopic nature of man-made stereoscopic images. Approximately 10%-15% of the population at large experience headaches while viewing simulated stereoscopic images and/or have difficulty in perceiving the stereoscopic aspects of simulated stereoscopic images.

The binocular dominance of one eye over the other can cause an image to appear flat. Mono-vision correction can prevent the resolution of depth. Other causes of impairment with respect to man-made or simulated stereoscopic images can include strabismus (the misalignment of where eyes are looking), refractive Amblyopia (“lazy eye”), and other visual development disorders. People with relatively minor cases of such visual disorders are often unaware of the problem and either see a flat image or only the most exaggerated stereoscopic effects when viewing simulated or man-made stereoscopic images.

Simulated stereoscopic images are not effectively perceived by people who have significant differences between their left and right eyes. The greater the differential, the less likely that the person can effectively perceive a simulated stereoscopic image. Nonetheless, the prior art affirmatively teaches away from the treating the left eye differently from the right eye even though 10%-15% of the population will not effectively be able to perceive the stereoscopic nature of such images. For example, U.S. Pat. No. 8,284,235 teaches that reducing the disparities (the opposite of purposely differentiation) between unequal eyes reduces the discomfort to the viewer. The prior art affirmatively teaches away from treating the eyes differently even in instances where the right/left differential between the eyes is significant.

### SUMMARY OF THE INVENTION

The invention is a system, apparatus, and method for enhancing stereoscopic images that includes a right/left differential filter (collectively the “system”). By modifying the left eye image and/or the right eye image to compensate for unequal eye capabilities, the ability of a human being to perceive stereoscopic images can be enhanced.

The system can be implemented in a wide variety of different electronic-based embodiments as well as non-electronic based embodiments. The system can include a wide range of different types of both relational/relative/dependent and non-relational/non-relative/independent filtration parameters.

### BRIEF DESCRIPTION OF THE DRAWINGS

Many features and inventive aspects of the system are illustrated in the following drawings:

FIG. 1a is an input-output diagram illustrating an example of an initial image being modified in accordance with a right/left differential.

FIG. 1b is a flow chart diagram illustrating an example of a method of enhancing a stereoscopic image using a right/left differential.

FIG. 1c is an input-output diagram illustrating an example of a right/left differential modifying a left eye image while leaving the right eye image unmodified.

FIG. 1d is an input-output diagram illustrating an example of a right/left differential modifying a right eye image while leaving the left eye image unmodified.

FIG. 1e is an input-output diagram illustrating an example of a right/left differential modifying both a right eye image and a left eye image.

FIG. 1f is an input-out diagram illustrating an example of different types of media components that can be used to implement a right/left differential filter.

FIG. 2a is a block diagram illustrating an example of how different types of filter parameters can correspond to different types of light attributes relating to the image.

FIG. 2b is a hierarchy diagram illustrating an example of the different types of light attributes that can be differentiated by the system.

FIG. 2c is a hierarchy diagram illustrating an example of different types of filter parameters that can be implemented by the system.

FIG. 3a is a diagram illustrating an example of some of the components of an electronic embodiment of the viewer.

FIG. 3b is a diagram illustrating an example of some of the components of an a non-electronic embodiment of the viewer.

FIG. 4a is a flow chart diagram illustrating an example of a method for identifying the right/left differential for a user.

FIG. 4b is a flow chart diagram illustrating an example of a method for enhancing the ability of a user to view stereoscopic images.

FIG. 5a is a diagram illustrating an example of a non-electronic stereoscopic viewer that can be worn on the head of a user and that involves lenses that are not directly connected to each other.

FIG. 5b is a diagram illustrating an example of a non-electronic stereoscopic viewer that can be worn on the head of a user and that involves lenses that are directly connected to each other.

FIG. 5c is a diagram illustrating an example of an electronic stereoscopic viewer that can be worn on the head of a user and that involves lenses that are not directly connected to each other.

FIG. 5d is a diagram illustrating an example of an electronic stereoscopic viewer that can be worn on the head of a user and that involves lenses that are directly connected to each other.

FIG. 5e is a diagram illustrating an example of a stereoscopic viewer that can be clipped onto a pair of conventional eye glasses.

FIG. 5f is a diagram illustrating an example of drop in eye-pieces that can be “dropped into” a stereoscopic viewer.

FIG. 5g is a diagram illustrating an example of a stereoscopic viewer with slots for “dropping in” replaceable eye pieces.

### DETAILED DESCRIPTION

The invention is a system, apparatus, and method for enhancing stereoscopic images that includes a right/left differential (collectively the “system”).

Some people are unable to properly perceive simulated stereoscopic images or even natural stereoscopic images (collectively “stereoscopic images”) because of differences between the left and right eye (the “right/left differential”). For such individuals, one eye can so dominate the other eye that when the images of the two eyes are fused together, the individual does not perceive the stereoscopic aspects of the image. The system can address the issue of eye domination head on by modifying the incoming image or images to specifically factor in the right/left differential for a particular person. For example, if the right eye is dominant over the left eye for the purposes of perceiving stereoscopic images, the image transmitted to the left eye could be brightened relative to the right eye to facilitate better stereoscopic perception. Conversely, the image transmitted to the right eye could be darkened relative to the image provided to the left eye to achieve the same or similar outcome. Still another alternative would be to do both, darken the image for the dominant eye and brighten the image for the non-dominant eye to a degree of magnitude that is consistent with the right/left differential for the particular individual.

Although many people have materially different eyesight capabilities, conventional approaches to simulated stereoscopic images take great strides to ignore the right/left differential. For example, most prior art approaches to the display of simulated stereoscopic images require treating the left eye image identical to the right eye image even though the fusion of the left eye image with the right eye image is substantially impacted by the differential in capabilities of the left and right eye. For example, U.S. Pat. No. 8,284,235 teaches that reducing the disparities (the opposite of purposeful differentiation) between unequal eyes reduces the discomfort to the viewer. The prior art affirmatively teaches away from treating the eyes differently even in instances where the right/left differential between the eyes is significant. Contrary to the prior art, the system seeks to address head on instead of avoiding the challenges to proper stereoscopic perception that results when one eye is sufficiently dominant over the other eye.

The system can use a right/left differential filter with respect to one or more relational/related/relative/dependent image parameters (“relational image parameters”) to selectively modify the images seen by one or more eyes. Relational image parameters relate to the right/left differential of the user of the system. Image or light attributes can be changed in response to the right/left differential of the user in order to enhance the ability of the user to perceive stereoscopic images. For example, the brightness of an image can be enhanced for the right eye image relative to the left eye image when the right/left differential indicates that the left eye is dominant over the right eye.

The system can also involve include the additional functionality of selectively modifying images based on one or more non-relational/non-related/independent image parameters (“non-relational image parameters”). Non-relational image parameters are parameters that are applied to each eye in absolute terms, not relative to a right/left differential. The modification of one or more non-relational light attributes subject to one or more non-relational filter parameters is an optional add-on to the system functionality of modifying one or more relational light attributes subject to one or more relational filter parameters defined by a right/left differential for the particular viewer.

The ability to filter stereoscopic images using one or more relational image parameters can significantly enhance the ability of users to perceive stereoscopic images. The system can also include the ability to filter images on the basis of non-relational image parameters.

Examples of light attributes than be modified in accordance with a right/left differential include but are not limited to brightness, hue, saturation, color, location, focus, contrast, magnification, distortion, image size, and resolution. Those same attributes can also be modified as non-relational light attributes.

### I. ALTERNATIVE EMBODIMENTS

No patent application can expressly disclose in words or in drawings, all of the potential embodiments of an invention. In accordance with the provisions of the patent statutes, the principles and modes of operation of the system are explained and illustrated in certain preferred embodiments. However, it must be understood that the system may be practiced otherwise than is specifically explained and illustrated without departing from its spirit or scope.

The description of the system provided below should be understood to include all novel and non-obvious combination of elements described herein, and claims may be presented in this or a later application to any novel non-obvious combination of these elements. Moreover, the foregoing embodiments are illustrative, and no single feature or element is essential to all possible combinations that may be claimed in this or a later application. The capability of modifying images in accordance with a right/left differential can be implemented using a wide variety of different technologies and components.

### II. OVERVIEW

Human beings perceive an image in “3D” by fusing together the image perceived by the right eye with the image perceived by the left eye. If one eye is too dominant with respect to the other eye, the fusing process will not allow the viewer to fully perceive the “3D” nature of the stereoscopic images.

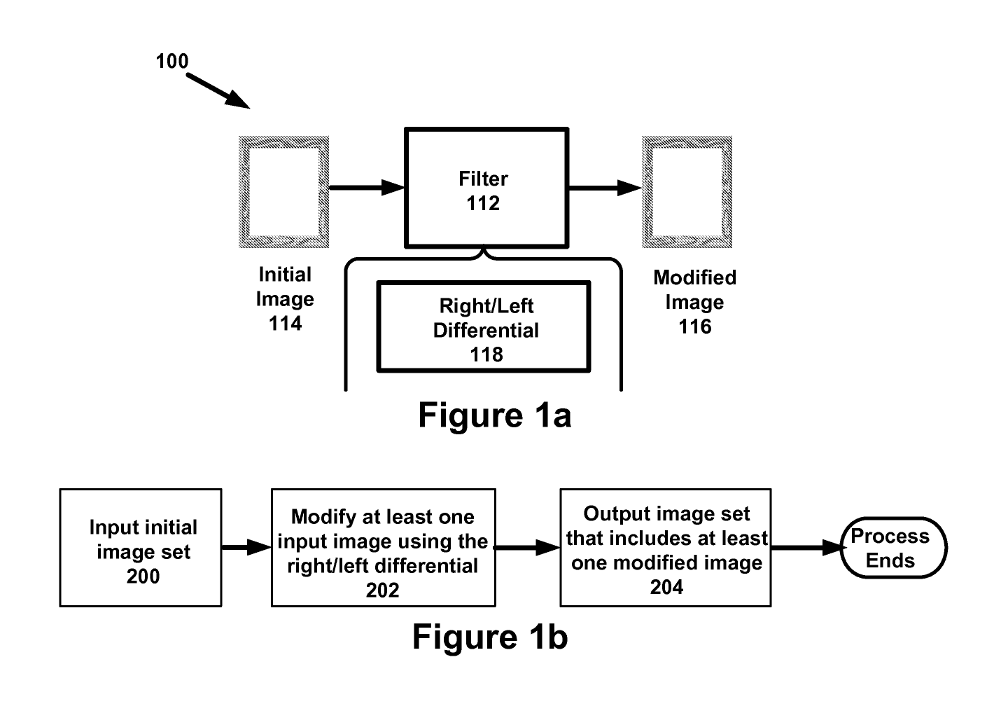

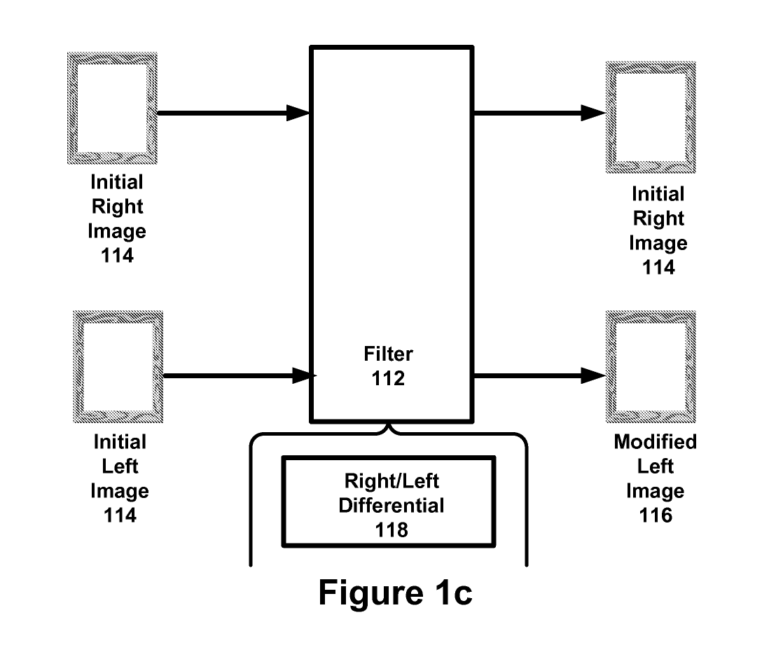

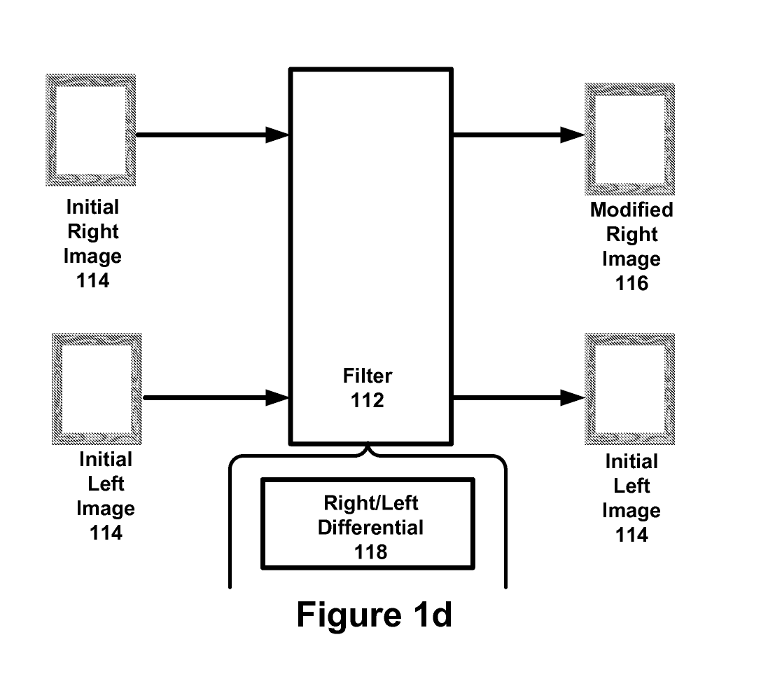

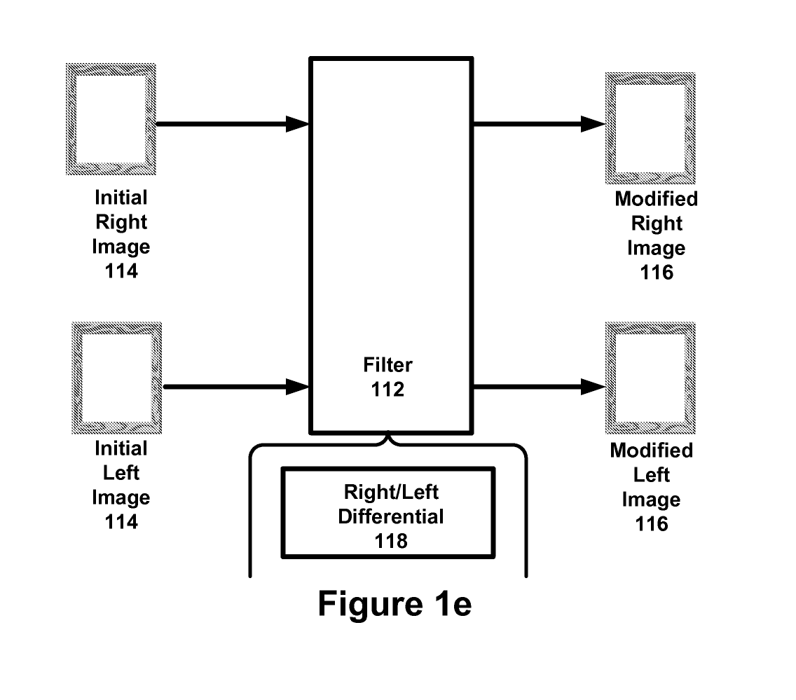

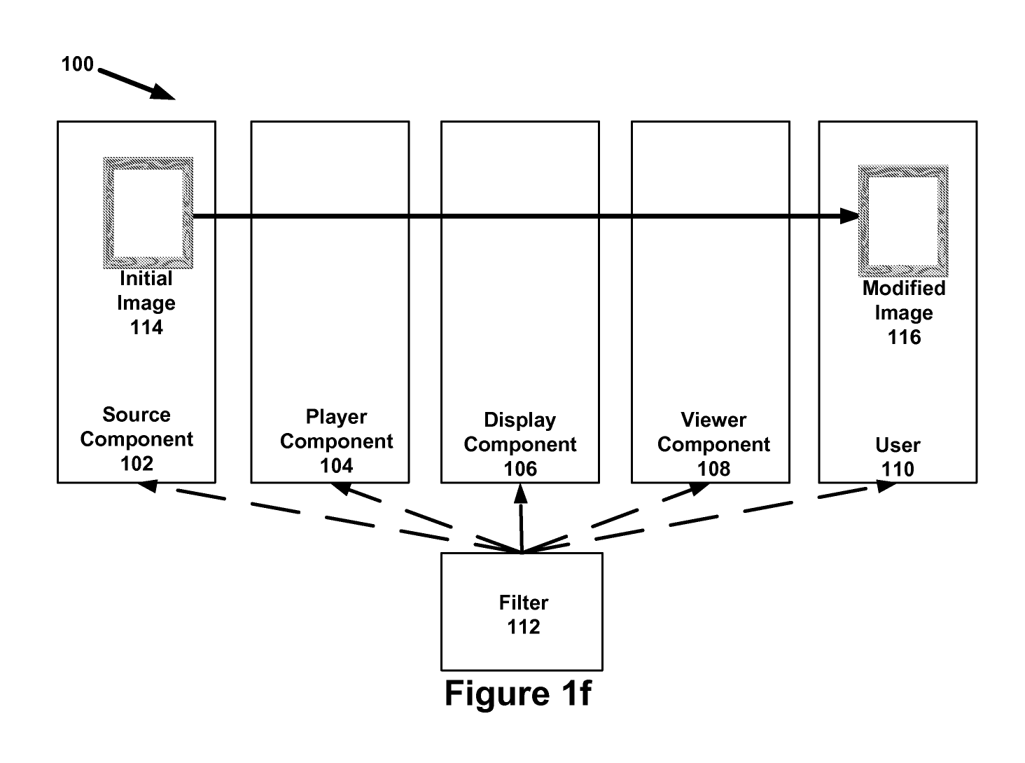

FIG. 1a illustrates an example a system 100 in which an initial image 114 is selectively modified by a filter 112 into a modified image 116 in accordance with a right/left differential 118. By selectively modifying the initial image 114 in accordance with the right/left differential 118, the system 100 can enhance the ability of a human being to perceive stereoscopic images. By way of example, if the right/left differential 118 identifies the viewer as having right eye dominance over the left eye by magnitude or metric “X”, then the one or more relational attributes can be modified by magnitude or metrix “X” for the image(s) 114 perceived by one eye relative to the other eye. Different eyes can be treated differently, in accordance with right/left differential 118 that is associated with the particular user of the system 100.

The display and perception of stereoscopic images will often involve a system 100 comprising of multiple components. The filter 112 embodying the right/left differential 118 can be embodied in or more of those component parts of the system 100. A component of the system 100 that includes a filter 112 is referred to as the apparatus. Different configurations of the system 100 and different methods of operation that can be implemented by the system 100 are discussed below.

Different embodiments of the system 100 can involve different filters 112 and different types and numbers of filter parameters. The system 100 can be described in a variety of different ways and implemented in a wide variety of different configurations.

A. Input-Output View

As illustrated in FIG. 1a, the system 100 can be described as a filter 112 that receives an initial image 114 as an input. The filter 112 then applies a right/left differential 118 to the initial image 114 to generate a modified image 116 that is the output of the filter 112. As discussed below, the filter 112 modifies one or more relational light attributes of the incoming image 114 in accordance with the relational parameters embodied in the filter 112.

Terms such as an input and output are typically used in the context of electronic and computer systems, but the terms are also applicable to non-electronic embodiments of the system 100. For example, in the context of a non-electronic embodiment of the system 100, the filter 112 could be the form of a film or lens that modifies the image without the use of electronic means. The output of the system 100 in that context is a modified image 116. In the context of conventional sun glasses, the natural unmodified image that hits the sunglasses is the input and the darkened image that comes out the other end is the output. In the context of electronic embodiments of the system 100, inputs and outputs can involve a potentially wide range of formats and types.

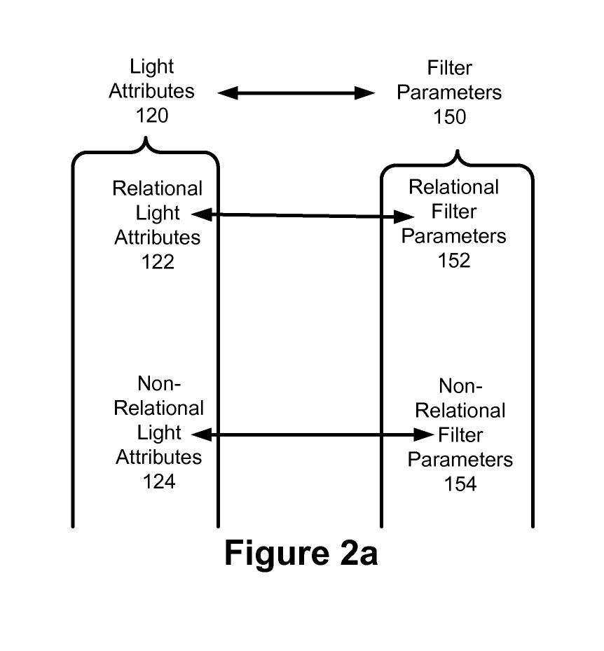

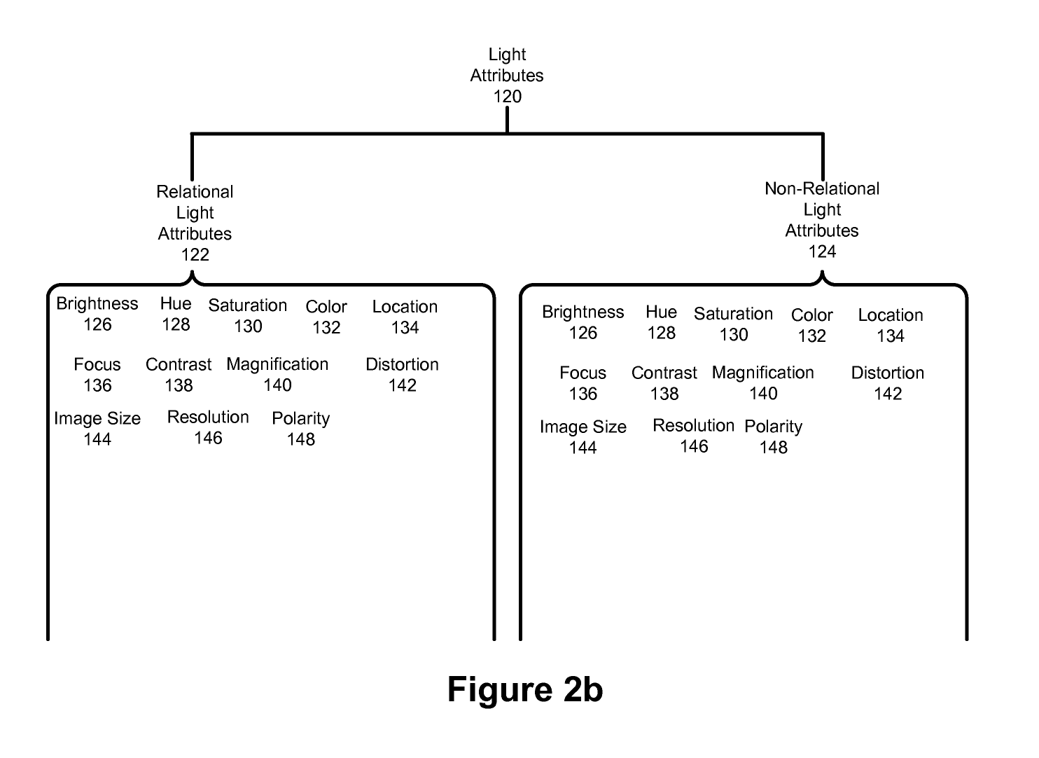

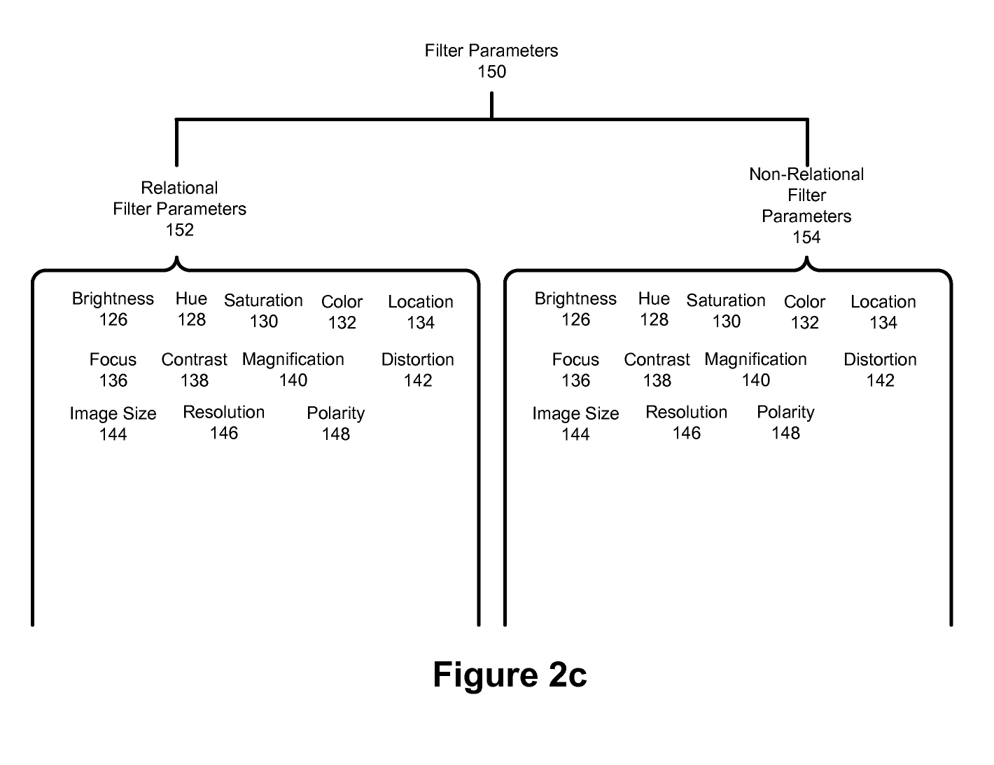

The filter 112 in FIG. 1a can apply the right/left differential 118 to one or more relational light attributes. In some embodiments of the system 100, the filter 112 can also modify an image with respect to non-relational light attributes. As illustrated in FIGS. 2a-2c and discussed in greater detail below, a wide variety of different light attributes 120 and corresponding filter parameters 150 can be used to configure the functionality of the system 100. Both light attributes 120 and filter parameters 150 can be broken down into categories of “relational” (dependent on the right/left differential 118) and “non-relational” (independent of the right/left differential 118). A wide range of different types of relational light attributes 122, non-relational light attributes 124, relational filter parameters 152, and non-relational filter parameters 154 can be incorporated into the system 100.

B. Process Flow View

FIG. 1b is a flow chart diagram illustrating an example of a method of enhancing a stereoscopic image 114 using a right/left differential 118 embodied in a filter 112 (which can also be referred to as a “right/left differential filter” or a “right/left differentiation” 112).

At 200, the initial image set comprising of an initial right eye image 114 and an initial left eye image 114 are inputted to the filter 112. These initial or unmodified images are such that given the viewer's right/left differential 118, the viewer's ability to perceive the depth and other stereoscopic aspects of the images would be substantially impeded if one or more of the images 114 are not modified in accordance with the right/left differential 118.

The term inputted is used broadly to include both electronic as well as non-electronic embodiments. In the context of non-electronic embodiment of the system 100, the image 114 is typically directed to through the filter 112 in the same way that light in the physical world is directed through a lens. In the context of electronic embodiments of the system 100, the inputting of images at 200 can involve the inputting of images 114 in the form of digitized data. The terms output and input are used with respect to both electronic as well as non-electronic embodiments of system 100 even though the mechanism of image transmission can vary widely in the various embodiments of the system 100.

At 202, either one or both of the initial images 114 in the image set (comprised of a right eye initial image 114 and a left eye initial image 114) are selectively modified in accordance with the right/left differential 118. So for example, in the context of an embodiment of the system 100 where the right/left differential 118 relates to brightness, one image 114 may be brightened or darkened with respect to the other. That process involves creating one or more modified images 116 with respect to the applicable light attribute 120/filter parameter 150.

At 204, the filter 112 outputs a set of output images that includes one or more modified images 116. In the case of physical light such as what can be viewed through otherwise conventional stereoscopic glasses at a movie theater, the output is in the form of modified light. In the case of embodiments of the system 100 that process and transmit images in the form of digitized information, the outputted set of images can be in a wide variety of different forms and formats.

After 204, the process ends. However, in the case of video, the process can be performed repetitively for each frame of the video.

C. Variations of Relational Processing Based on the Right/Left Differential

FIGS. 1c-1e illustrate three different output variations with respect to the impact of the filter 112 on both the initial right eye image 114 and the initial left eye image 114.

1. Right Eye Image Unchanged

In the example of FIG. 1c, the application of the right/left differential 118 to the incoming image set results in a modified left eye image 116 but the initial right eye image 114 is unchanged. In an embodiment of the system 100 where brightness is the filter parameter, the modified left eye image 116 can be either darkened or brightened with respect to the initial left eye image 114 while the initial right eye image 114 is not changed in any way. Similar processing can be performed for any of the light attributes 120 and filter parameters 150 illustrated in FIGS. 2a-2c or that are discussed below.

2. Left Eye Image Unchanged

In the example of FIG. 1d, the application of the right/left differential 118 to the incoming image set results in a modified right eye image 116 but the initial left eye image 114 is unchanged. In an embodiment of the system 100 where brightness is the filter parameter, the modified right eye image 116 can be either darkened or brightened with respect to the initial right eye image 114 while the initial left eye image 114 is not changed in any way. Similar processing can be performed for any of the light attributes 120 and filter parameters 150 illustrated in FIGS. 2a-2c or that are discussed below.

3. Both Images Modified

In the example of FIG. 1e, both of the initial images 114 are modified in accordance with the right/left differential 118. So for example, in the context of brightness, if the right/left differential 118 calls of a certain magnitude of difference between the right eye image and the left eye image, 50% (or some other percentage) of that outcome can be achieved by modifying the right eye image and 50% (or some other percentage) of that outcome can be achieved by modifying the left eye image. Similar processing can be performed for any of the light attributes 120 and filter parameters 150 illustrated in FIGS. 2a-2c or that are discussed below.

D. System Components

As discussed above, the system 100 can be implemented in a wide variety of different configurations, including the form a single integrated viewer apparatus. FIG. 1f is an input-out diagram illustrating an example of different components of the system 100 that can be used to implement the right/left differential filter 112. As illustrated in FIG. 1f, the filter 112 can be exist in any of the different components or even in multiple components. At some point in the process, an initial image 114 is selectively modified into a modified image 116 in accordance with the filter 112.

Different system 100 configurations are illustrated in Table 1 and are discussed below. The examples are not intended to be comprehensive, but illustrative of contexts of where the system 100 can be incorporated into common prior art supply chains for the delivery of media.

TABLE 1

| Source | Player | Display | Viewer |
|---|---|---|---|
| Film media at movie | Projector | Passive screen | Head gear (such as |
| theater | | | “3-D” glasses), if any |
| DVD/disc at home | DVD Player | Active screen (TV, | Head gear (such as |
| | | monitor, portable | “3-D” glasses), if any |
| | | electronic device with | |
| | | screen) | |
| Movie or | Cable box, satellite | Active screen (TV, | Head gear (such as |
| programming | dish, antenna, TV | monitor, portable | “3-D” glasses), if any |
| broadcast from | | electronic device with | |
| satellite, cable, or TV | | screen) | |
| station | | | |
| Internet streaming | Software on | Active screen (TV, | Head gear (such as |
| content from | computer, tablet, or | monitor, portable | “3-D” glasses), if any |
| “broadcaster” | smart phone that | electronic device with | |
| | provides for playing | screen) | |
| | media | | |
| Video game | Video game console, | Active screen (TV, | Head gear (such as |
| | computer, tablet | monitor, portable | “3-D” glasses), if any |
| | computer, smart | electronic device with | |
| | phone | screen) | |
| Media streamed or | Smart phone, tablet | Active screen (TV, | Film covering the |
| downloaded from the | computer, other types | monitor, portable | active screen |
| Internet | of computers | electronic device with | |
| | | screen) | |
| Any source of media | Any device capable of | Active screen (TV, | Film covering the |
| playable on a screen | displaying an image | monitor, portable | active screen |
| | on a screen | electronic device with | |
| | | screen) | |

The distribution chain of media that can be processed by the system 100 can be implemented in a wide variety of different component configurations. In some instances a single device can serve the function of more than one component. By way of example, portable television goggles could constitute a player component 104, a display component 106, and a viewer component 108 as a single unitary device.

1. Source Component

A source component 102 (or simply the “source” 102 or “media content” 102) is the source of the image or images being enhanced by the operation of the system 100. FIG. 1f uses a box diagram to illustrate the source component 102 because the source component 102 is potentially everything in the distribution chain that happens to the media prior to the arrival of the media at the player component 104. Examples of source components 102 can include but are not limited to a disc, film reel, or similar storage mechanism for media; media broadcast on a cable, satellite, or terrestrial television station; and media broadcast via internet streaming. A filter 112 that uses a right/left differential 118 to modify images can be embedded within the source component 102. So for example, a user 110 watching the source media 102 on a television in their home could have the modifications embodied in the right/left differential 118 implemented directly in the source 102 itself, obviating the need to implement the modifications in the player 104, the display 106, or the viewer 108.

2. Player Component

A player component 104 is the device used to “play” the source 102. Common examples of player components 104 (or simply “players” 104) can include DVD players, cable boxes, satellite dishes, desktop computers, laptop computers, tablet computers, smart phones, and television sets. In many instances, the player component 104 and the display component 106 are integrated into the same device. For example, computers with integrated monitors (including tablets and smart phones) are both players 104 and displays 106. A filter 112 that uses a right/left differential 118 to modify images can be embedded within the player component 104. One or more player components 104 can be used to deliver media to a display component 106.

The player component 104 box in FIG. 1f can include multiple devices that communicate with each other, as well as various wires and other transmission capabilities. FIG. 1f is illustrated in a block diagram format to emphasize that a multitude of hardware configurations and distribution chain alternatives can benefit from the ability of the system 100 to selectively modify an image 114 with respect to one eye relative to another eye on the basis of the right/left differential 118 associated with the particular user 110.

3. Display Component

A display component 106 (or “display” 106) is typically some type of screen. The display component 106 can be a passive screen, such as a screen in a movie theater. The display component 106 can also be an active screen, such as the display on a television set, a computer monitor, or the screen on a tablet computer or smart phone. A filter 112 that uses a right/left differential 118 to modify images can be embedded within the display component 106. By way of example, the modifications embodied in the right/left differential 118 can be implemented within the television set itself, allowing the user 110 to use standard viewer components 108 without any modification. As with the other components discussed above, the display component 106 is illustrated in the form of a block diagram to emphasize that a wide range of hardware configurations can benefit from the functionality of selectively modifying initial images 114 using a right/left differential 118 that relates to the eyesight capabilities of the user 110.

4. Viewer Component

A viewer component 108 (or “viewer” 108) is any component or series of components that is between the display 106 and the user 110. Examples of viewers can include glasses that are worn to see a “3D” movie as well as other headgear worn by a user 110 to perceive the media. Viewer components 108 can also include film coatings placed on a display such as smart phone screen, a tablet screen, or other screen that includes a filter 112 that uses a right/left differential 118 to modify images.

Some viewer components 108 can be powered devices with electronic processors and the ability to modify incoming images 114 used various algorithms Other viewer components 108 can function without electricity, such as conventional “3D” glasses that have been modified in accordance with the right/left differential 118.

E. User

In most embodiments of the system 100, the user 110 will be a human being with two eyes. In some embodiments of the system 100, other types of two eyed animals could also constitute users 110 of the system 100.

### III. IMAGE ATTRIBUES AND FILTER PARAMETERS

FIG. 2a is a block diagram illustrating an example of the relationship between a light attribute 120 and a filter parameter 150. Subsidiary to that relationship are the corresponding relationships (a) between relational light attributes 122 and relational filter parameters 152 and (b) and between non-relational light attributes 124 and non-relational filter parameters 154. The application of filter parameters 150 by the system 100 results in modifications to the corresponding light attributes 120. The application of relational filter parameters 152 by the system 100 results in modifications to the corresponding relational light attributes 122 of the images. The application of non-relational parameters 154 by the system 100 results in modifications to the corresponding non-relational light attributes 124 of the images.

Stereoscopic viewing involves the right eye and left eye receiving corresponding images 114 that are fused together in order to perceive “depth” and other “3D” aspects of the stereoscopic images.

The system 100 can selectively modify an incoming image 114, transforming that incoming image 114 into a modified image 116. Modifications are made to incoming or initial images 114 with respect to (a) one or more image attributes and/or (b) light attributes corresponding to the incoming image (collectively “light attributes 120”). As mentioned above, modifications to light attributes 120 are triggered by the implementation of corresponding filter parameters 150 into the applicable filter 112.

A. Light Attributes

FIG. 2a is a hierarchy diagram illustrating an example of the different categories of image attributes and light attributes (collectively “light attributes” 120) that can be differentiated by the system 100. Specific examples of light attributes 120 are provided in FIG. 2b. Virtually any light attribute 120 can be modified in a manner that is done relative to the right/left differential 118 and the image corresponding to the other eye (“relational light attributes” 122). Virtually any light attribute 120 can also be modified in a manner that is not relative to the right/left differential 118 and is made without reference to the image corresponding to the other eye (“non-relational light attributes” 124).

B. Filter Parameters

FIG. 2a is a hierarchy diagram illustrating an example of the different categories of filter parameters 150 that can be implemented in one or more filters 112 to trigger corresponding modifications to light attributes 120. Specific examples of filter parameters 150 are provided in FIG. 2c. Virtually any filter parameter 150 can be implemented in a manner that is relative to the other image for the other eye and the right/left differential 118 (“relational filter parameters” 152) as well as in manner that is independent of the processing for the image corresponding to the other eye and the right/left differential 118 (“non-relational filter parameters” 154).

C. Light Attributes/Filter Parameters

As illustrated in FIG. 2a, filter parameters 150 correspond to light attributes 120 in that the filter parameters 150 incorporated into the filter 112 of the system 100 will selectively trigger modifications based on those filter parameters 150 to the corresponding light attributes 120. Thus, light attributes 120 and filter parameters 150 are to some extent mirror images of each other. FIGS. 2b and 2c illustrate examples of specific light attributes 120/filter parameters 150.

1. Brightness

An image 114 can be modified with respect to a brightness attribute 126. For digital images, this can be done on pixel by pixel basis. For analog images, this can be done by conventional brightening/darkening methodologies.

Many embodiments of the system 100 that modify only one relational light attribute 122 in accordance with a right/left differential 118 will use brightness 126 as the applicable attribute.

2. Hue

An image 114 can be modified with respect to a hue attribute 128. Hue 128 refers to a gradation of variety of color. Hue 128 can be modified using digital as well as non-digital means.

In the context of relational processing, hue 128 can be modified to make the incoming image 114 for the weaker eye more distinct with respect to the dominant eye, evening the playing field by the magnitude of the right/left differential 118.

3. Saturation

An image 114 can be modified with respect to a saturation attribute 130. Saturation 130 the degree of chroma or purity of a color; the degree of freedom from admixture with white. Saturation 130 can be modified using digital as well as non-digital means.

In the context of relational processing, saturation 130 can be modified to make the incoming image 114 for the weaker eye more distinct, evening the playing field by the magnitude of the right/left differential 118.

4. Color

An image 114 can be modified with respect to a color attribute 132. Color 130 is the quality of light usually determined visually by measurement of hue, saturation, and brightness of the reflected light; saturation or chroma; hue the degree of chroma or purity of a color; the degree of freedom from admixture with white. Saturation 130 can be modified using digital as well as non-digital means.

In the context of relational processing, saturation 130 can be modified to make the incoming image 114 for the weaker eye more distinct, evening the playing field by the magnitude of the right/left differential 118.

5. Location

An image 114 can be modified with respect to a location attribute 134. Location 134 can adjusted for eye focus position and other physical characteristics such as vertical alignment or pupillary separation differences. This can be accomplished in a variety of ways. Eyepieces 180 can be independently driven and the entire system 10 can be individually aligned to each eye. Another alignment mechanism is to pivot the final optic to redirect the collimated light of the virtual retina display into the eye of the user 110. Another adjustment can be to digitally shift the image on the DLP (digital light display), particularly if it is oversized, to correct for the physical location (both horizontally and vertically) of image projection.

In the context of relational processing, location 134 can be modified to make the incoming image 114 for the weaker eye more distinct, evening the playing field by the magnitude of the right/left differential 118.

6. Focus

An image 114 can be modified with respect to a focus attribute 136. Focus 136 can also be adjusted in many different ways. This is a key technique used to compensate for myopia and/or monovision. In a virtual retina display this can be accomplished by blurring the image in the digital source, adding a diffusive element to the projection path to ‘blur’ the light, or adjusting the distance the final display optic is from the reflective element. This changes the focus of the virtual image in a manner similar to adjusting the focus on binoculars or a microscope. If this is done uniformly, both images appear in focus. If binocular rivalry prevents this from generating a fused image, the dominant eye can be blurred to force the viewer to use the non-dominant eye and possible achieve fusion and the perception of “3D”.

In the context of relational processing, focus 136 can be modified to make the incoming image 114 for the weaker eye more distinct, evening the playing field by the magnitude of the right/left differential 118.

7. Contrast

An image 114 can be modified with respect to a contrast attribute 138. Contrast 138 is the relative difference between light and dark in an image. Contrast 138 can be modified using digital as well as non-digital means.

In the context of relational processing, contrast 138 can be modified to make the incoming image 114 for the weaker eye more distinct, evening the playing field by the magnitude of the right/left differential 118.

8. Magnification

An image 114 can be modified with respect to a magnification attribute 140. Magnification 140 is the ratio in size of an image to the size of the object represented in the image. Magnification 140 can be modified using digital as well as non-digital means.

In the context of relational processing, magnification 140 can be modified to make the incoming image 114 for the weaker eye more prominent, evening the playing field by the magnitude of the right/left differential 118.

9. Distortion

An image 114 can be modified with respect to a distortion attribute 142. Distortion 142 is an aberration of a lens or a system of lenses in which the magnification of the object varies with the lateral distance from the axis of the lens. Distortion 142 can be modified using digital as well as non-digital means.

In the context of relational processing, distortion 142 can be modified to make the incoming image 114 for the weaker eye more prominent, evening the playing field by the magnitude of the right/left differential 118.

10. Image Size

An image 114 can be modified with respect to an image size attribute 144. Image size 144 refers to the size of the area of an image, which is often a function of pixel size in a digital image. Image size 144 can be modified using digital as well as non-digital means.

In the context of relational processing, image size 144 can be modified to make the incoming image 114 for the weaker eye more prominent, evening the playing field by the magnitude of the right/left differential 118.

11. Resolution

An image 114 can be modified with respect to a resolution attribute 146. Resolution size 146 refers to the quality of an image, and is often a function of pixel size in the context of a digital image. Resolution 146 can be modified using digital as well as non-digital means.

In the context of relational processing, resolution 146 can be modified to make the incoming image 114 for the weaker eye more prominent, evening the playing field by the magnitude of the right/left differential 118.

12. Polarity

An image 114 can be modified with respect to a polarity attribute 148 of the light used to transmit the image 114. Polarity 148 can be modified using digital as well as non-digital means.

In the context of relational processing, polarity 148 can be modified to make the incoming image 114 for the weaker eye more prominent, evening the playing field by the magnitude of the right/left differential 118.

13. Other Attributes/Parameters

Any attribute/parameter that can be used to process or modify an image, or the light used to transmit an image, can potentially serve as a light attribute 120 and filter parameter 150 that is used by the system 100 to selectively modify images.

### IV. COMPONENT VIEWS AND DESCRIPTIONS

The system 100 can be implemented in a wide variety of different configurations. In some configurations, the filter 112 used to modify the incoming images 114 will not be an electronic device. In other embodiments, the filter 112 will be an electronic device.

A. Electronic Embodiments

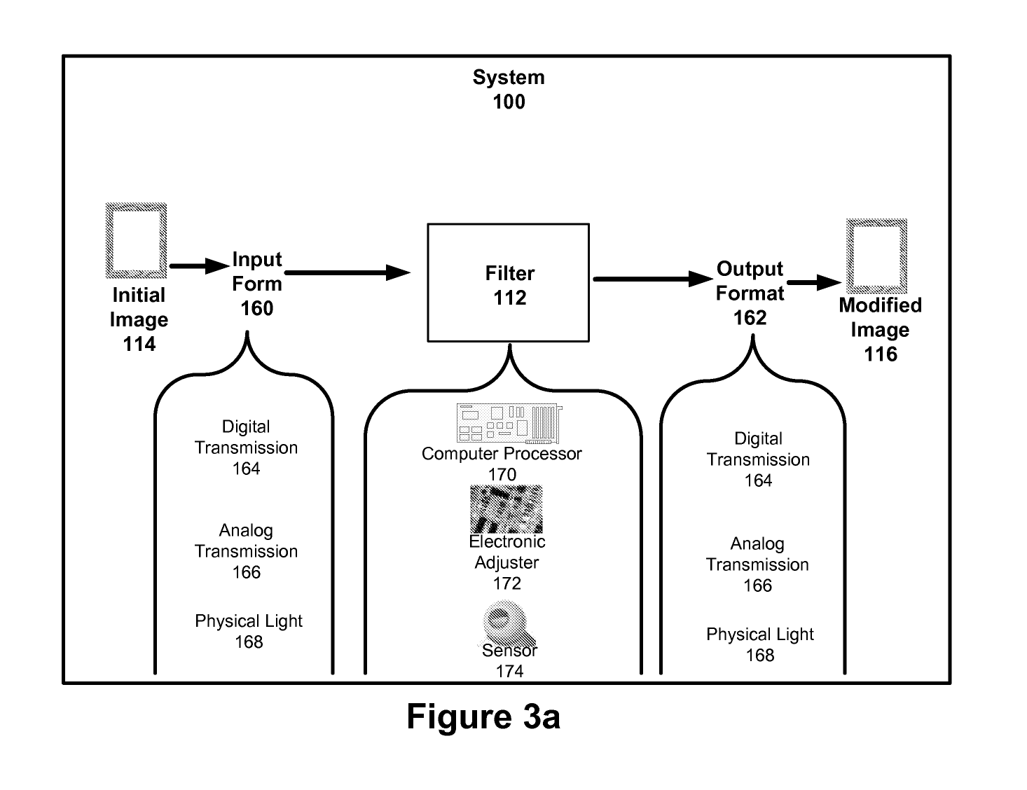

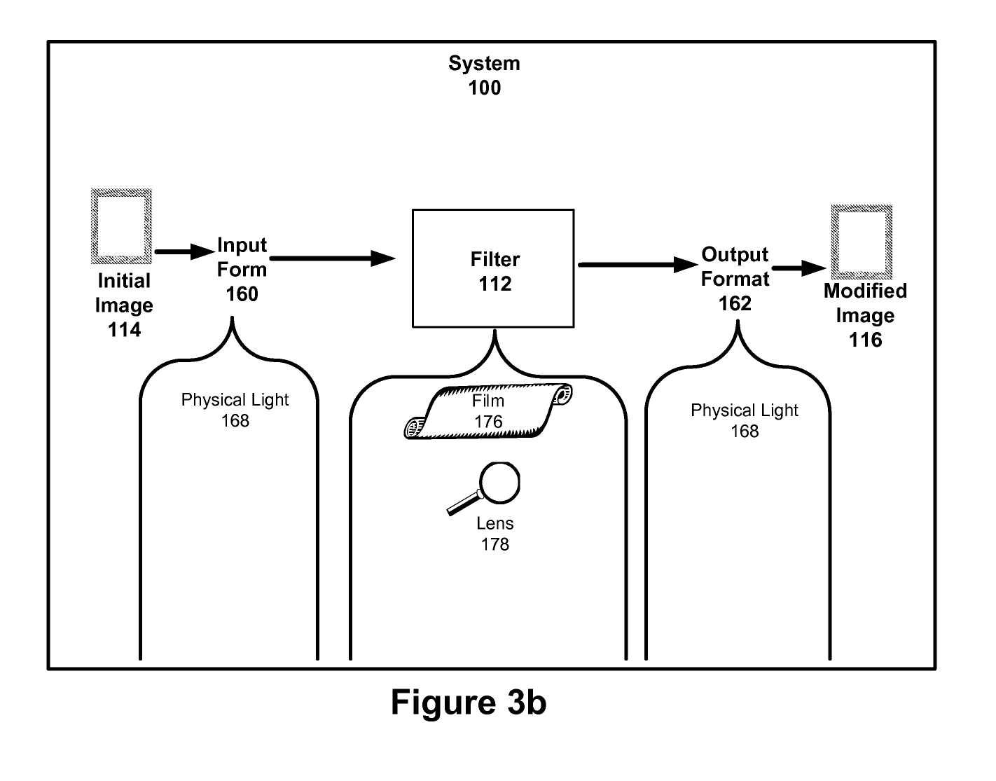

FIG. 3a is a diagram illustrating an example of some of the components of an embodiment of the system 100 that involves a filter apparatus 112 that is an electronics-based device utilizing electrical power.

1. Input Form/Format

Initial images 114 can be transmitted to the filter 112 in a wide variety of different forms, including the form a digital transmission 164, an analog transmission 166, and as physical light 168.

2. Filter Components

A filter 112 can utilize a variety of different components to receive and perform processing on the various input forms 160. A computer processor 170 can be used to to perform virtually any type of processing to the image 114. An electronic adjuster 172 is another electronics-based mechanism to provide modifications that does not involve the full fledged flexibility of a computer processor 170. A sensor 174 can used to convert the input 160 into any potentially desired form, including from physical light 168 as well as into physical light 168.

3. Output Form/Format

Any form of image 114 that can be potentially received as an input 160 can also be used to transmit the form/format of the modified image 116.

B. Non-Electronic Embodiments

FIG. 3b is a diagram illustrating an example of some of the components of an a non-electronic embodiment of the system 100. It is important to understand that by non-electronic, what is meant that the device implementing the filter 112 is not electronic. Other devices in the system 100 may involve electronically powered components. For example, non-electronic “3D” glasses may be used to implement the filter 112, but powered devices such as a movie projector or television set are used to deliver the source 102 to the user 110

A. Input/Output Formats

The primary difference between the non-electronic embodiments of the filter 112 and electronic embodiments of the filter 112 is that the input 160 and output 162 formats of the image will be physical light 168 rather than electronic transmissions.

B. Filter Components

Instead of implementing the filter 112 electronically, the filter 112 is embodied in a set of lenses 178 with one lens corresponding to the left eye and another lens corresponding to the right eye. Lenses 178 can be implemented in a variety of different ways, including a film 176 (such as a thin plastic film placed over a smart phone or similar display component 106) and/or an eyepiece 180, which is illustrated and discussed below. Sets of lenses 178 can be divided in terms of which eye they service. Two lenses 178 can be permanently fused together in one unitary piece while still having different sections devoted to different eyes of the user 110.

### V. PROCESS FLOW VIEWS AND DESCRIPTIONS

The processing of the system 100 can be broken down into various processes and sub-processes. Such functionality can be performed in a wide variety of different alternative embodiments.

A. Identifying the Right/Left Differential

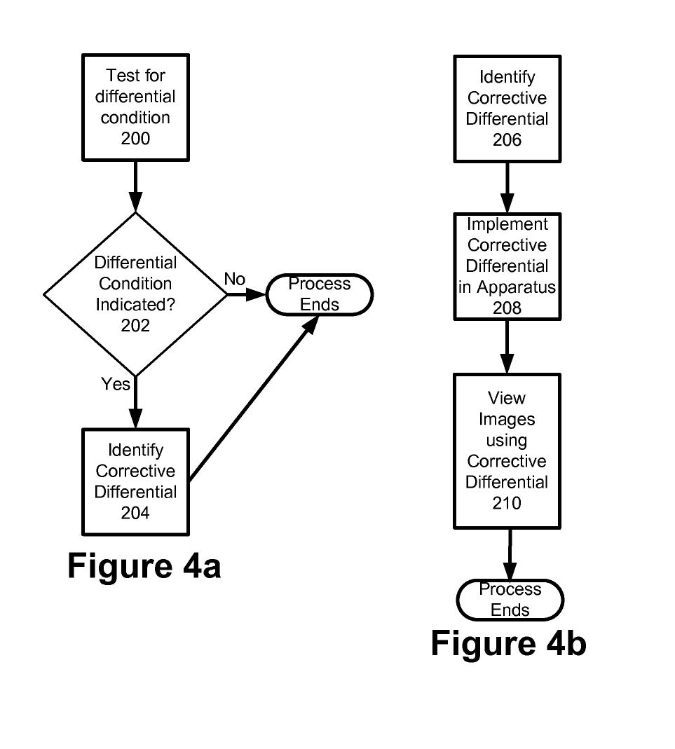

FIG. 4a is a flow chart diagram illustrating an example of a method for identifying the right/left differential 118 for a user 110.

At 200, the user is subjected to one or more tests for a right/left differential 118. These tests can be fully automated (at kiosk, given to users 110 online in the comfort of their own homes, etc), fully manual by an appropriate trained person, or in a manner that is partially automated and partially manual.

If no differential condition is indicated at 202, the process ends. If a right/left differential 118 condition is identified at 202 (or alternatively, if a condition of sufficient magnitude is identified at 202), the corrective right/left differential 118 for that individual user 110 is identified at 204 prior to the process completing.

In many embodiments, the right/left differential 118 for a specific user 110 can be stored so that the user 110 is not repeatedly subject to duplicative testing. In some embodiments, the right/left differential 118 is a specific metric, while in other embodiments it can be a category associated with a range of magnitudes. It is anticipated that kiosks could be set up to test users 110 in a convenient manner, but inside and outside of locations such as movie theaters, consumer electronics stores etc.

B. Process for Enhancing an Image

FIG. 4b is a flow chart diagram illustrating an example of a method for enhancing the ability of a user 110 to view stereoscopic images.

At 206, the corrective differential is identified. This process is illustrated on a first time basis in FIG. 4a, but can also be accessed from an applicable computer network on which the information is stored for the convenience of the user 110.

At 208 the applicable corrective right/left differential 118 is implemented in the applicable component of the system 100.

At 210, enhanced images are viewed by the user 110 on the basis of the right/left differential 118 associated with the user at 206 and implemented in the applicable device at 208.

Then the process ends.

### VI. VIEWER EMBODIMENTS

As discussed above, the filter 112 can be implemented in the source component 102, the player component 104, the display component 106, and/or the viewer component 108. However, as the right/left differential 119 is ultimately something that varies from individual to individual, the view component 108 will be be the desired mechanism for implementing the filter 112 because the viewer component 108 is used only by one user 110 at a time.

A. Non-Electronic Viewer with Separate Lenses

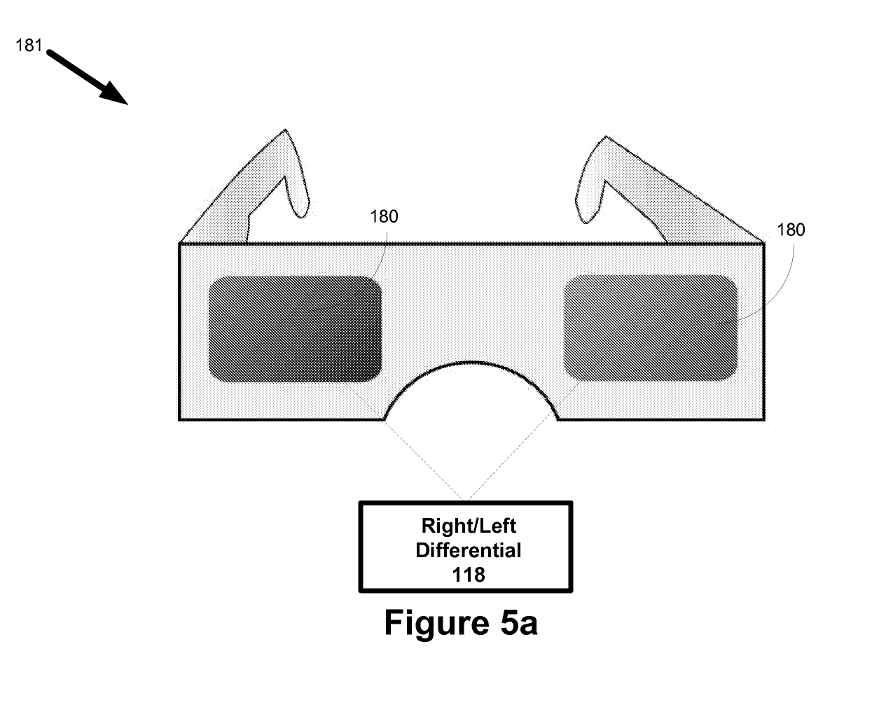

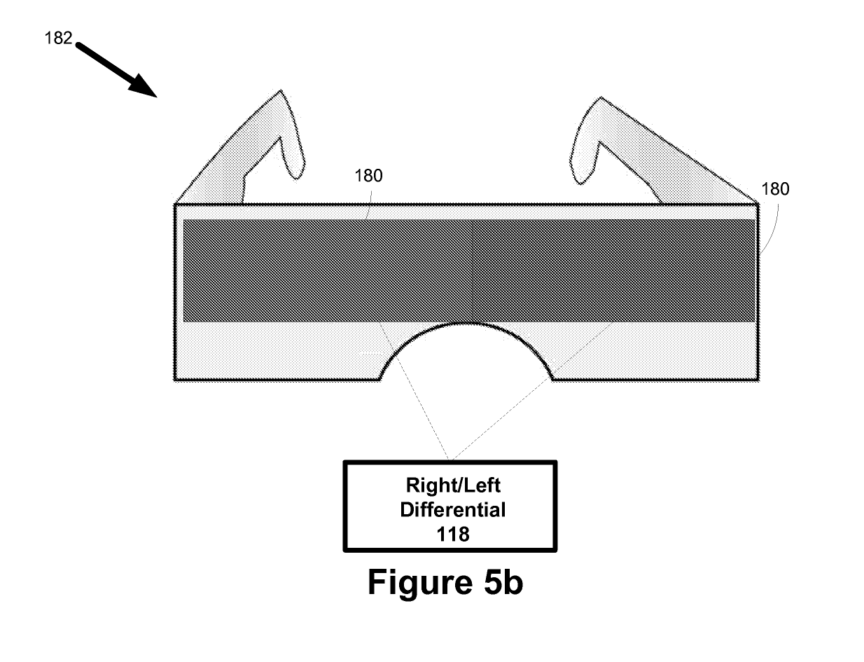

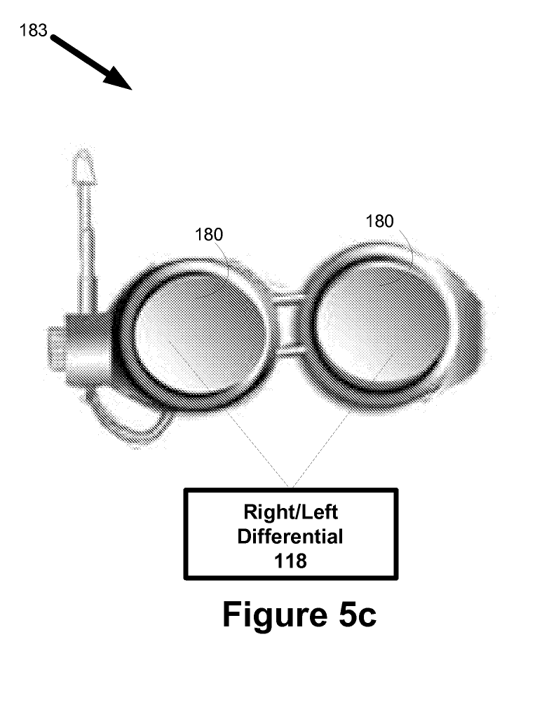

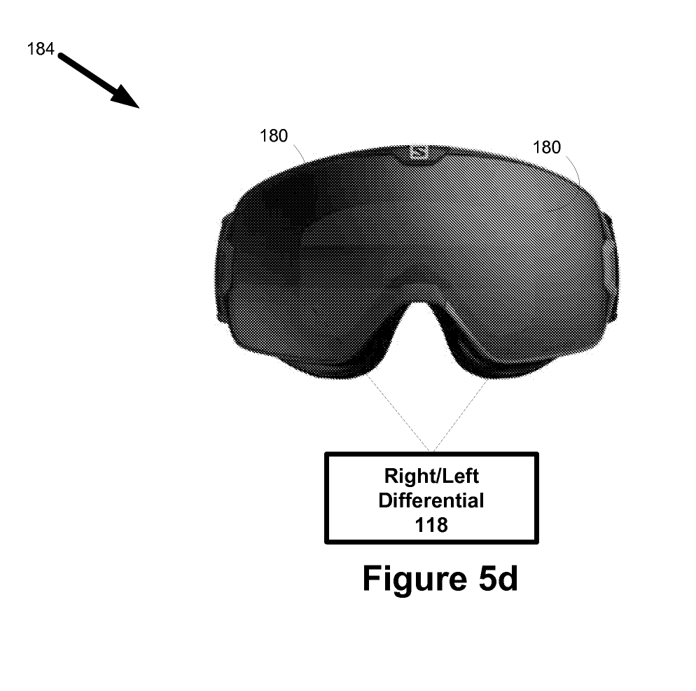

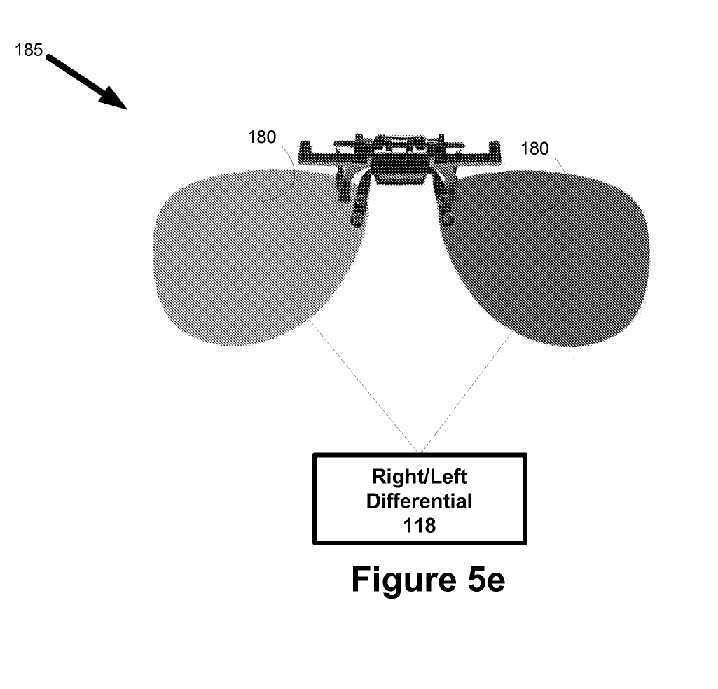

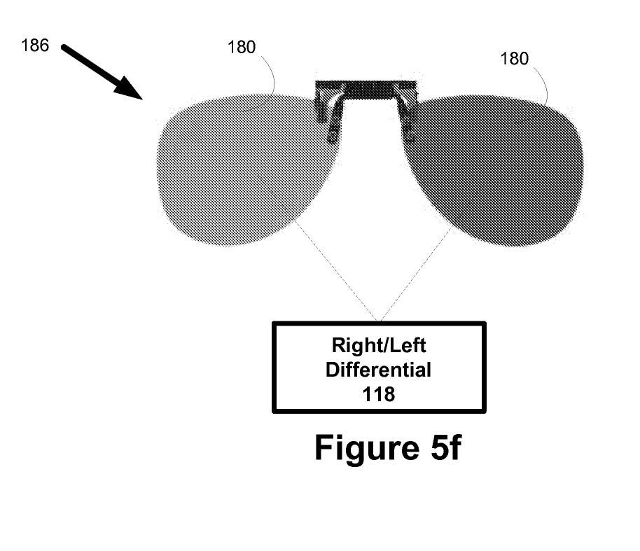

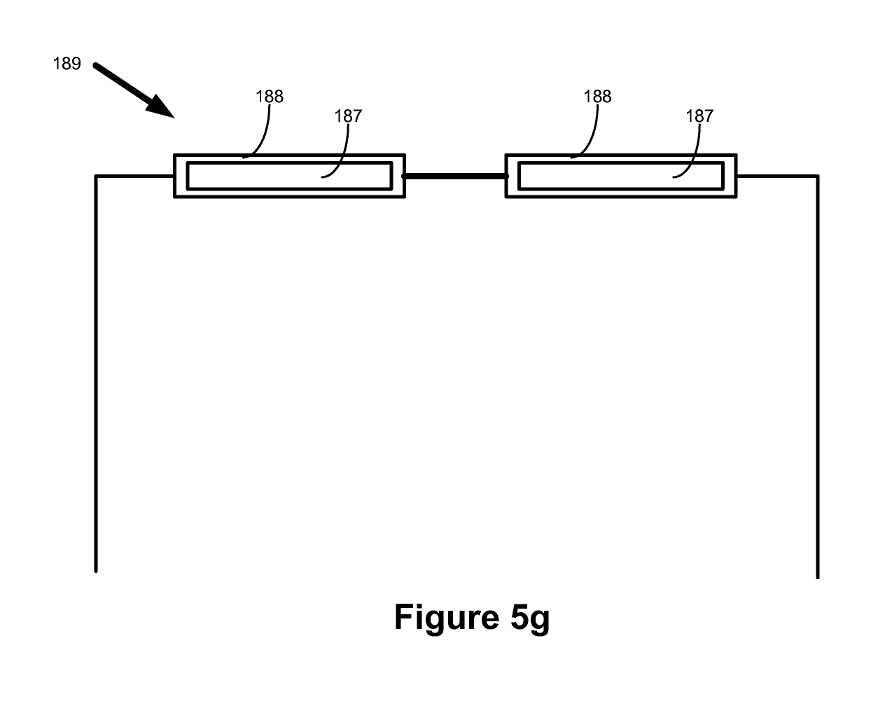

FIG. 5a is a diagram illustrating an example of a non-electronic stereoscopic viewer 181 that can be worn on the head of a user 110 and that involves lenses 178 that are not directly connected to each other. As illustrated in FIG. 5a, the lenses 178 are in the form of eyepieces 180.

B. Non-Electronic Viewer with Connected Lenses

FIG. 5b is a diagram illustrating an example of a non-electronic stereoscopic viewer 182 that can be worn on the head of a user 110 and that involves lenses 178 that are directly connected to each other. As illustrated in FIG. 5b, the lenses 178 are in the form of eyepieces 180.

C. Electronic Viewer with Separate Lenses

FIG. 5c is a diagram illustrating an example of an electronic stereoscopic viewer 183 that can be worn on the head of a user 110 and that involves lenses 178 that are not directly connected to each other. As illustrated in FIG. 5c, the lenses 178 are in the form of eyepieces 180.

D. Electronic Viewer with Connected Lenses

FIG. 5d is a diagram illustrating an example of an electronic stereoscopic viewer 184 that can be worn on the head of a user 110 and that involves lenses 178 that are directly connected to each other. As illustrated in FIG. 5d, the lenses 178 are in the form of eyepieces 180.

E. Clip on Lenses

FIG. 5e is a diagram illustrating an example of a stereoscopic viewer 185 that can be clipped onto a pair of conventional eye glasses. As illustrated in FIG. 5e, the lenses 178 are in the form of eyepieces 180.

F. Drop-in Lenses

FIG. 5f is a diagram illustrating an example of drop in eye-pieces 186 that can be “dropped into” a stereoscopic viewer as illustrated in FIG. 5g. As illustrated in FIG. 5g, there are two compartments 188 with accessible slots 189 to hold the drop in eye-piece 186.

### VII. TREATMENT OF UNDERLYING CONDITION

The original motivating factor for the conception of the system 100 was to enhance the ability of a large subset of individuals to perceive stereoscopic images in the context of film, television, video games, and other types of man-made media. However, the system 100 can also be used to address the underlying the medical condition of the user 110 that results in the right/left differential 118.

By impeding the stronger eye and/or enhancing the weaker eye, the system 100 can be used to change the right/left differential 118 of a user 110 over time such that the right/left differential 118 for that user will be reduced or even essentially eliminated. Instead of strengthening the weaker eye with respect to the stronger eye by completely blocking the stronger eye using an eye patch or similar technology, the system 100 can be used to incrementally strengthen the relative weakness of the weaker eye and/or incrementally weaken the relative dominance of the dominant eye. By compensating for the right/left differential 118, the system 100 can over time reduce the magnitude of the right/left differential 118, and potentially eliminate the need for such an adjustment in what is displayed to the applicable user 110.

### VIII. PURPOSEFUL INCREASING OF THE RIGHT/LEFT DIFFERENTIAL

The original motivating factor for the conception of the system 100 was to enhance the ability of a large subset of individuals to perceive stereoscopic images in the context of film, television, video games and other man-made media. However, the functionality of the system 100 could be used in reverse to increase the dominance of one eye over the other.

Put another way, the right/left differential 118 can be set to increase rather than decrease the inequality between the two eyes. The ability to artificially enhance eye dominance can be particularly useful in activities such as hitting a baseball (where the dominant eye faces the pitcher), hitting a golf bowl (where the dominant eye faces the ball), shooting, and other activities.

The technical capability to artificially induce and increase eye dominance may also be useful in the context of mimicking certain challenging environments for military, police, and other personnel who may confront different visual environments in stressful situations.

### VIII. DEFINITIONS/INDEX OF ELEMENTS

The terms below are hereby defined as following for the purposes of understanding the system 100 as disclosed and claimed.

A. Apparatus

Any device that includes a filter 112 that provides for selectively modifying images based on a right/left differential 118. An apparatus can involve modifying one or more relational light attributes 122 based on one or more relational filter parameters 152. The filter of the apparatus can also involve modifying zero or more non-relational light attributes 124 using zero or more non-relational filter parameters 154. The apparatus can be a source component 102, a player component 104, a display component 106, or a viewer component 108. Some embodiments of the apparatus will exclusively utilize powered electronic means while other embodiments will involve no electronic means. Other embodiments can involve both some electronic and well as non-electronic filtration technologies.

B. System

The system 100 is the aggregate operating environment that includes an apparatus.

C. Filter

Any technology capable of transforming an initial image 114 into a modified image 116 can serve the system 100 as a filter 112. A filter 112 that selectively modifies at least one relational light attribute 122 on the basis of at least one relational filter parameter 152 can be referred to as “right/left differential filter” 112. If brightness 126 was the relational light attribute 122 that is modified by the “right/left differential filter” 112 on the basis of brightness 126 as relational filter parameter 152, such a filter 112 can be referred to as a “right/left differential brightness filter” 112. Similar naming conventions can be used for other attributes 120 and parameters 150. Filters 112 can also be used to modify non-relational light attributes 124 based on non-relational filter parameters 152.

D. Media

Media means collectively everything from a singular initial image 114 that the system 100 provides for selectively modifying into a modified image 116 through to large numbers of initial images 114 that are used collectively as video.

E. System Components

The distribution chain of media that can be processed by the system 100 can be implemented in a wide variety of different component configurations. In some instances a single device can serve the function of more than one component. By way of example, portable television goggles could constitute a player component 104, a display component 106, and a viewer component 108 as a single unitary device.

1. Source Component

A source component 102 (or simply the “source” 102) is the source of the image or images being enhanced by the operation of the system 100. As illustrated in FIG. 1f, the source component 102 is potentially everything in the distribution chain that happens to the media prior to the arrival of the media at the player component 104. Examples of source components 102 can include but are not limited to a disc or similar storage mechanism for media; media broadcast on a cable, satellite, or terrestrial television station; and media broadcast via internet streaming. A filter 112 that uses a right/left differential 118 to modify images can be embedded within the source component 102.

2. Player Component

A player component 104 is the device used to “play” the source 102. Common examples of player components 104 (or simply “players” 104) can include DVD players, cable boxes, satellite dishes, desktop computers, laptop computers, tablet computers, smart phones, and television sets. In many instances, the player component 104 and the display component 106 are integrated into the same device. For example, computers with integrated monitors (including tablets and smart phones) are both players 104 and displays 106. A filter 112 that uses a right/left differential 118 to modify images can be embedded within the player component 104. One or more player components 104 can be used to deliver media to a display component 106.

3. Display Component

A display component 106 (or “display” 106) is typically some type of screen. The display component 106 can be a passive screen, such as a screen in a movie theater. The display component 106 can also be an active screen, such as the display on a television set, a computer monitor, or the screen on a tablet computer or smart phone. A filter 112 that uses a right/left differential 118 to modify images can be embedded within the display component 106.

4. Viewer Component

A viewer component 108 (which can also be referred to as the “stereoscopic viewer” 108 or simply the “viewer” 108) is any component or series of components that is between the display 106 and the user 110. Examples of viewers can include glasses that are worn to see a “3D” movie as well as other headgear worn by a user 110 to perceive the media. Viewer components 108 can also include film coatings placed on a display such as smart phone screen, a tablet screen, or other screen that includes a filter 112 that uses a right/left differential 118 to modify images.

1. A stereoscopic viewer adapted to be worn on a head of a human being having a left eye and a right eye, said stereoscopic viewer comprising:
a frame;
a plurality of lenses connected to said frame, said plurality of lenses including a relational light attribute, a right/left differential pertaining to said relational light attribute, a first lens and a second lens;
wherein said first lens pertains to the right eye of the human being;
wherein said second lens pertains to the left eye of the human being;
wherein said first lens differs from said second lens with respect to said relational light attribute by the magnitude of said right/left differential;
wherein said frame provides for positioning said first lens in front of the right eye of the human being; and
wherein said frame provides for positioning said second lens in front of the left eye of the human being.

2. The stereoscopic viewer of claim 1, wherein said relational light attribute is a brightness.

3. The stereoscopic viewer of claim 2, wherein at least one said lens is darkened.

4. The stereoscopic viewer of claim 2, wherein at least one said lens is brightened.

5. The stereoscopic viewer of claim 1, wherein said right/left differential is selectively identified for the human being wearing said stereoscopic viewer.

6. The stereoscopic viewer of claim 1, said plurality of lenses including a plurality of right/left differentials pertaining to a plurality of relational light attributes, wherein each said right/left differential corresponds to at least one relational light attribute, and wherein said first lens differs from said second lens with respect to said plurality of relational light attributes by the magnitude of said right/left differentials.

7. The stereoscopic viewer of claim 6, wherein said plurality of relational light attributes include at least three of: (a) a brightness; (b) a focus; (c) a location; (d) a hue; (e) a saturation; (f) a color; (g) a contrast; (h) a distortion; (i) a polarity; and (j) an image size.

8. The stereoscopic viewer of claim 6, said plurality of lenses further including a non-relational light attribute that is modified for at least one said lens.

9. The stereoscopic viewer of claim 1, wherein said frame is a pair of eyeglasses, and wherein said lenses are adapted to be attached to said frame.

10. The stereoscopic viewer of claim 1, wherein said plurality of lenses are drop-in filters adapted to be dropped in to a plurality of slots in said frame.

11. The stereoscopic viewer of claim 1, wherein said stereoscopic viewer is not electronic and does not utilize a power source.

12. The stereoscopic viewer of claim 1, wherein said plurality of lenses are comprised of at least one of: (a) a film place over a plurality of eye pieces; and (b) a plurality of eye pieces.

13. The stereoscopic viewer of claim 1, wherein said right/left differential for said stereoscopic viewer can be modified.

14. The stereoscopic viewer of claim 1, wherein said frame is adapted to provide for the removal of said plurality of lenses.

15. The stereoscopic viewer of claim 1, wherein said right/left differential is identified at a kiosk.

16. The stereoscopic viewer of claim 15, wherein said right/left differential is identified as one of a plurality of predefined viewer categories.

17. The stereoscopic viewer of claim 16, wherein said predefined viewer category is stored on a database along with a unique identifier associated with the human being for whom said predefined viewer category applies.

18. The stereoscopic viewer of claim 1, wherein said first lens is in direct permanent contact with said second lens.

19. A stereoscopic viewer adapted to be worn on a head of a human being having a left eye and a right eye, said stereoscopic viewer comprising:
a frame;
a plurality of lenses connected to said frame, said plurality of lenses including a plurality of relational light attributes, a plurality of right/left differentials, a first lens and a second lens;
wherein said first lens first lens corresponds to the right eye of the human being;
wherein said second lens corresponds to the left eye of the human being;
wherein said first lens differs from said second lens with respect to said relational light attribute by the magnitude of said right/left differential;
wherein said frame provides for positioning said first lens in front of the right eye of the human being;
wherein said frame provides for positioning said second lens in front of the left eye of the human being; and
wherein said plurality of relational light attributes includes a brightness and a polarity.

20. A stereoscopic viewer adapted to be worn on a head of a human being having a left eye and a right eye, said stereoscopic viewer comprising:
a frame;
a plurality of lenses connected to said frame, said plurality of lenses including a plurality of relational light attributes, a plurality of right/left differentials, a first lens and a second lens;
wherein said first lens first lens corresponds to the right eye of the human being;
wherein said second lens corresponds to the left eye of the human being;
wherein said first lens differs from said second lens with respect to said relational light attribute by the magnitude of said right/left differential;
wherein said frame provides for positioning said first lens in front of the right eye of the human being;
wherein said frame provides for positioning said second lens in front of the left eye of the human being;
wherein said stereoscopic viewer is an electronic device with an LCD display; and
wherein said plurality of relational light attributes includes a brightness.
